(19) United States
(12) Patent Application Publication
(10) Pub. No.: US 2024/0154297 A1
(43) Pub. Date: May 9, 2024

(54) ANTENNA ARRANGEMENT FOR AN ELECTRONIC VEHICLE KEY

(71) Applicant: Continental Automotive Technologies GmbH, Hannover (DE)

(72) Inventor: Razvan Bejinaru, Timisoara (RO)

(73) Assignee: Continental Automotive Technologies GmbH, Hannover (DE)

(21) Appl. No.: 18/279,968

(22) PCT Filed: Mar. 2, 2022
(86) PCT No.: PCT/EP2022/055311

§ 371 Date: Sep. 1, 2023

(30) Foreign Application Priority Data
Mar. 4, 2021 (EP) 21465507.8
Mar. 10, 2021 (DE) 10 2021 202 319.3

(51) Int. Cl. H01Q 1/32; H01Q 1/38; H01Q 5/25; H01Q 9/42

(52) U.S. Cl. CPC H01Q 1/3241; H01Q 1/38; H01Q 5/25; H01Q 9/42

(57) ABSTRACT

An antenna arrangement for an electronic key includes an antenna, and an antenna circuit configured to control the antenna, wherein the antenna and the antenna circuit are arranged on a printed circuit board, the antenna arrangement is configured to transmit and receive ultra-wide band signals or signals according to a Bluetooth standard, and the antenna circuit includes a filter arrangement configured to filter signals received by and to be sent by the antenna, wherein the filter arrangement includes a capacitance formed by at least two conducting paths formed on the printed circuit board.

### BACKGROUND

The current invention relates to an antenna arrangement, in particular an antenna arrangement for an electronic vehicle key.

Most vehicles today may be unlocked and remotely started using an electronic vehicle key. Some “start and stop” access systems are well known in which the user needs to press an unlocking button from the electronic remote key to unlock or lock the vehicle, start the engine of the vehicle, or open a trunk of the vehicle, for example. Such an electronic vehicle key usually has to be inserted into an immobilizer station located inside the vehicle which recognizes the vehicle key and allows the user to start the vehicle. Such systems replace the originally known ignition switch systems. Other “start and stop” access systems do not require the user to press a button or to insert the key in an immobilizer in order to unlock or lock the vehicle or to start the engine. Such a “start and stop” access system is called a passive start and entry system, or remote keyless entry system (RKE). With passive start and entry systems, the vehicle may be unlocked automatically when the key is detected within a certain range from the vehicle. In order to start the vehicle, a start button within the vehicle usually has to be pressed.

Such an electronic vehicle key communicates with the vehicle using wireless technology. For this reason, an electronic vehicle key usually comprises two or even more different antennas. For example, an electronic vehicle key may comprise at least one low frequency (LF) antenna, one ultrahigh frequency (UHF) antenna, an ultra-wide band (UWB) antenna, and an antenna for Bluetooth communication. Bluetooth or Bluetooth Low Energy (BLE) communication may be used, for example for transmitting all kind of information (e.g., tire pressure, fuel status, etc.) from the vehicle to the vehicle key or to a portable electronic device (e.g., smartphone). For each antenna, a filter stage needs to be provided. The filter stage usually is rather costly and requires a certain amount of space.

### BRIEF SUMMARY

There is a need to provide an antenna arrangement for an electronic vehicle key which has comparably small space requirements and can be implemented at comparably low costs.

This problem is solved by an antenna arrangement and an electronic vehicle key according to the independent claims. Configurations and further developments of the invention are the subject of the dependent claims.

An antenna arrangement for an electronic key includes an antenna, and an antenna circuit configured to control the antenna, wherein the antenna and the antenna circuit are arranged on a printed circuit board, the antenna arrangement is configured to transmit and receive ultra-wide band signals or signals according to a Bluetooth standard, and the antenna circuit comprises a filter arrangement configured to filter signals received by and to be sent by the antenna, wherein the filter arrangement comprises a capacitance formed by at least two conducting paths formed on the printed circuit board.

Such an antenna arrangement can be formed in a cost-effective way, because the filter arrangement can be formed very cost efficiently. Only the material to form the at least two conducting paths on the printed circuit board is needed to form the filter arrangement.

The capacitance can comprise a bi-spiral shape comprising a first spiral conducting path and a second spiral conducting path spiraling into each other.

In this way, a filter arrangement can be formed that has a satisfactory performance for many applications.

The first spiral conducting path and the second spiral conducting path can each have a width in a horizontal direction of between 0.1 and 0.2 mm, wherein the horizontal direction is a direction parallel to a surface of the printed circuit board on which the first spiral conducting path and the second spiral conducting path are formed.

In this way, a filter arrangement can be formed that has a satisfactory performance for many applications.

The first spiral conducting path and the second spiral conducting path can each have a width in the horizontal direction of 0.14 mm.

The first spiral conducting path can be coupled to a first conducting path, and the second spiral conducting path can be coupled to a second conducting path.

The first conducting path and the second conducting path can each have a width in the horizontal direction of between 0.5 and 1.5 mm.

The first conducting path and the second conducting path can each have a width in the horizontal direction of 0.9 mm.

The first conducting path and the second conducting path can be 50Ω microstrip lines.

In this way, a filter arrangement can be formed that has a satisfactory performance for many applications, in particular for ultra-wide band and Bluetooth antennas.

The at least two conducting paths can comprise copper.

This allows to form the filter arrangement, and therefore the antenna arrangement, in a very cost effective way.

The at least two conducting paths can have a thickness in a vertical direction of between 0.4 and 0.6 mm, wherein the vertical direction is a direction perpendicular to the surface of the printed circuit board on which the conducting paths are formed.

In this way, a filter arrangement can be formed that has a satisfactory performance for many applications.

The antenna can comprise a conducting path on the printed circuit board.

The antenna can be a monopole antenna or an inverted-F antenna.

A monopole antenna, for example, can be used for UWB transmission, and an inverted-F antenna can be used for Bluetooth or Bluetooth Low Energy transmission.

An electronic vehicle key comprises an antenna arrangement.

Examples are now explained with reference to the drawings. In the drawings the same reference characters denote like features.

### BRIEF DESCRIPTION OF THE DRAWINGS

FIG. 1 schematically illustrates an antenna arrangement according to one example.

FIG. 2 schematically illustrates an antenna arrangement arranged on a printed circuit board according to one example.

FIG. 3 schematically illustrates a filter arrangement according to one example.

FIG. 4 schematically illustrates in a diagram different graphs with respect to the filter arrangement of FIG. 3.

FIG. 5 schematically illustrates a filter arrangement according to another example.

FIG. 6 schematically illustrates in a diagram different graphs with respect to the filter arrangement of FIG. 5.

### DETAILED DESCRIPTION

In the following Figures, only such elements are illustrated that are useful for the understanding of the present invention. The filter arrangement, the antenna arrangement and the electronic vehicle key described below may comprise more than the exemplary elements illustrated in the Figures. However, any additional elements that are not needed for the implementation of the present invention have been omitted for the sake of clarity.

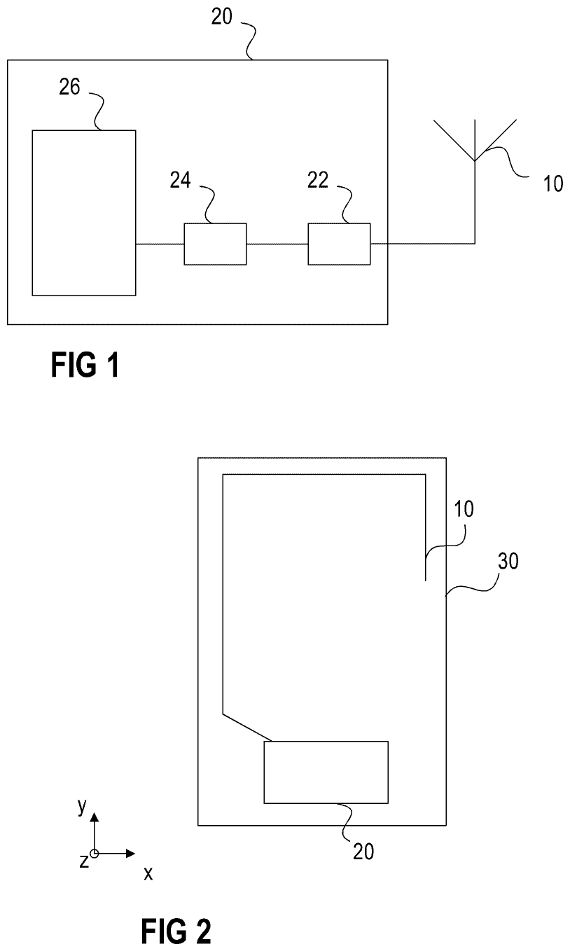

FIG. 1 illustrates an antenna arrangement that may be implemented in an electronic vehicle key. Signals may be sent between a vehicle and the electronic vehicle key (vehicle and electronic key not specifically illustrated in FIG. 1). For example, the electronic vehicle key may send inquiry signals to the vehicle to indicate the desire of a user to unlock/lock the vehicle. Further, authentication signals may be sent between the electronic vehicle key and the vehicle, for example, in order to prevent unauthorized users (unauthorized keys) from unlocking or starting the vehicle. Many other signals may be sent between the electronic vehicle key and the vehicle for many different applications.

An electronic vehicle key, therefore, may comprise different antennas. One antenna 10 and corresponding antenna circuit 20 are schematically illustrated in FIG. 1. The antenna 10 can be an ultra-wide band (UWB) antenna, for example. Ultra-wide band is a radio technology that can use a very low energy level for short-range, high bandwidth communications over a large portion of the radio spectrum. The antenna 10, however, can also be an antenna that is configured to transmit and receive signals according to a Bluetooth standard at a frequency of 2.4 GHz, for example.

The antenna arrangement illustrated in FIG. 1 comprises an antenna circuit 20, the antenna circuit 20 comprising a matching circuit 22, a filter stage or filter arrangement 24, and a controller 26. The matching circuit 22 can be configured to match the input impedance of the antenna 10 to the output impedance of the antenna circuit 20. The matching circuit 22 can comprise capacitors and inductances, for example. The filter arrangement 24 is configured to filter the signals received and signals to be sent by the antenna 10. The filter arrangement 24 can comprise a front-end band pass filter, for example, to reduce or even avoid spurious emissions during transmission of signals, and to reduce or even avoid in-band noise that might negatively affect the demodulation during reception of signals. The controller 26 is configured to control the function of the antenna circuit 20 and to process the received signals and/or the signals to be sent via the antenna 10.

Filter arrangements for antenna circuits often include ceramic filters or so-called SAW filters. Such filters generally have a very satisfying performance, but are rather expensive.

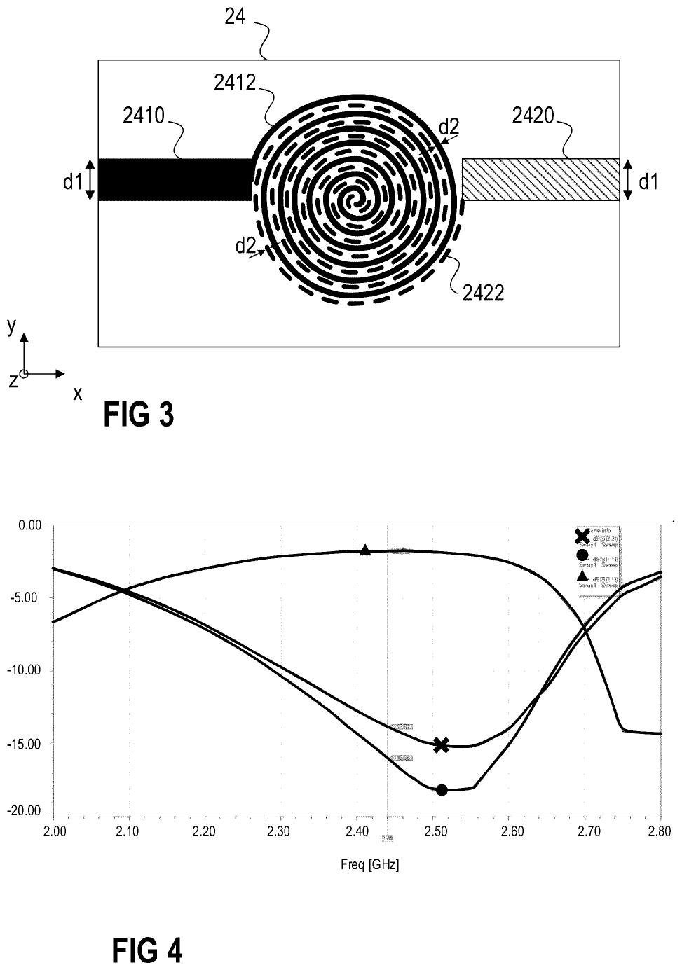

Now referring to FIG. 2, a printed circuit board 30 is schematically illustrated. The antenna 10 is arranged on the printed circuit board 30. For example, the antenna 10 can be formed by a conducting path arranged on the printed circuit board 30. The antenna 10 can be a monopole antenna or an inverted-F antenna, for example. In FIG. 2, a monopole antenna is schematically illustrated. The antenna circuit 20 can also be arranged on the printed circuit board 30. The filter arrangement 24 can comprise a capacitance that is formed by at least two conducting paths on the printed circuit board 30. This is schematically illustrated in FIG. 3. The filter arrangement 24 illustrated in FIG. 3 can be used for a Bluetooth antenna 10, for example. The filter arrangement 24 comprises a bi-spiral shape. The bi-spiral shape comprises a first spiral conducting path 2412, and a second spiral conducting path 2422. The first spiral conducting path 2412 can be coupled to a first conducting path 2410 and the second spiral conducting path 2422 can be coupled to a second conducting path 2420. The second spiral conducting path 2422 is illustrated with a dashed line in FIG. 3 for illustration purposes only, and in particular to be able to clearly distinguish the second spiral conducting path 2422 from the first spiral conducting path 2412. The second spiral conducting path 2422, however, is formed by a continuous conducting path on the printed circuit board 30. The first spiral conducting path 2412 and the second spiral conducting path 2422 each form a spiral and spiral into each other, thereby forming a capacitor. Each of the first spiral conducting path 2412 and the second spiral conducting path 2422 can form at least three full turns, for example. According to one example, each of the first spiral conducting path 2412 and the second spiral conducting path 2422 forms between three and ten full turns.

The first spiral conducting path 2412 and the second spiral conducting path 2422 have a small width d2 in a horizontal direction as compared to the width d1 of the first conducting path 2410 and the second conducting path 2420 in a horizontal direction. The horizontal direction is a direction parallel to a surface of the printed circuit board 30 on which the first spiral conducting path 2412 and the second spiral conducting path 2422 are formed. The width d1 of the first conducting path 2410 and the second conducting path 2420 can be between 0.5 and 1.5 mm (millimeter), for example. According to one example, the width d1 of the first conducting path 2410 and the second conducting path 2420 is 0.9 mm. The width d2 of the first spiral conducting path 2412 and the second spiral conducting path 2422 can be between 0.1 and 0.2 mm, for example. According to one example, width d2 of the first spiral conducting path 2412 and the second spiral conducting path 2422 is 0.14 mm. A thickness of the first conducting path 2410, the second conducting path 2420, the first spiral conducting path 2412, and the second spiral conducting path 2422 in a vertical direction z can be between 0.4 and 0.6 mm, for example. According to one example, the thickness is 0.5 mm. The vertical direction z is a direction perpendicular to a surface of the printed circuit board 30 on which the first spiral conducting path 2412 and the second spiral conducting path 2422 are formed.

The first conducting path 2410 and the second conducting path 2420 can be configured to function as an input line and an output line, respectively, and can be implemented as 50Q microstrip lines, for example.

The first conducting path 2410, the second conducting path 2420, the first spiral conducting path 2412, and the second spiral conducting path 2422 can comprise copper, for example.

The filter arrangement 24, therefore, can be implemented in a very cost-effective way. The material that is needed to form the filter arrangement 24 on the printed circuit board 30 is generally very cheap. The filter arrangement 24 only requires a certain amount of space on the printed circuit board 30. The performance of the described filter arrangement 24 is somewhat inferior as compared to SAW filters or ceramic filters, but may be acceptable for many applications in favor of the reduced costs.

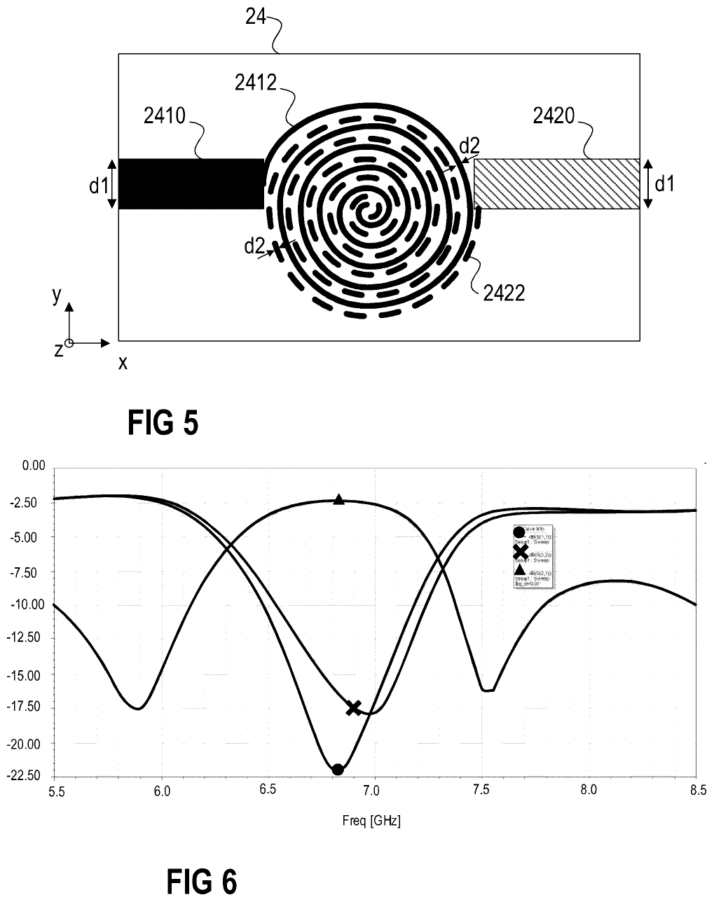

A similar filter arrangement 24 is schematically illustrated in FIG. 5 for an ultra-wide band antenna.

The filter arrangements 24 described above provide a satisfactory transmission and low insertion losses for those frequencies that are common for ultra-wide band and Bluetooth transmission. Outside of the concerned frequency bands, insertion losses are increased such that any unwanted signals outside of the desired frequency bands will be blocked. This is schematically illustrated in FIGS. 4 (for Bluetooth) and FIG. 6 (for ultrawide band).

As can be seen in FIG. 4, for reception in-band (between about 2.4 and 2.5 GHz) insertion losses are about 1.79 dB (curve marked with triangle). Insertion losses increase to 10 dB or more for frequencies above 2.7 GHz. The frequency response is also illustrated in FIG. 4 for input (curve marked with cross) and output (curve marked with dot).

As can be seen in FIG. 6, for reception in-band (between about 6.5 and 7.2 GHz) insertion losses are about 2 dB (curve marked with triangle). The bandwidth is approximately 500 MHz, which is sufficient for an ultra-wide band channel. Insertion losses increase to 8 dB or more for frequencies above 7.3 GHz or below 6.2 GHz. The frequency response is also illustrated in FIG. 6 for input (curve marked with cross) and output (curve marked with dot).

The filter arrangement 24 has been described with respect to Bluetooth and ultra-wide band transmission above. However, the filter arrangement can be adapted for other frequency bands. The quality of the filter arrangement 24 can depend on the quality of the printed circuit board 30.

### LIST OF REFERENCE SIGNS

10 antenna
20 antenna circuit
22 matching circuit
24 filter arrangement
2410 first conducting path
2412 first spiral conducting path
2420 second conducting path
2422 second spiral conducting path
26 controller
30 circuit board

1. An antenna arrangement for an electronic key comprises
an antenna; and
an antenna circuit configured to control the antenna; wherein
the antenna and the antenna circuit are arranged on a printed circuit board,
the antenna arrangement is configured to transmit and receive ultra-wide band signals or signals according to a Bluetooth standard, and
the antenna circuit comprises a filter arrangement configured to filter signals received by and to be sent by the antenna, wherein the filter arrangement comprises a capacitance formed by at least two conducting paths formed on the printed circuit board.

2. The antenna arrangement of claim 1, wherein the capacitance comprises a bi-spiral shape comprising a first spiral conducting path and a second spiral conducting path spiraling into each other.

3. The antenna arrangement of claim 2, wherein the first spiral conducting path and the second spiral conducting path each have a width in a horizontal direction of between 0.1 and 0.2 mm, wherein the horizontal direction is a direction parallel to a surface of the printed circuit board on which the first spiral conducting path and the second spiral conducting path are formed.

4. The antenna arrangement of claim 3, wherein the first spiral conducting path and the second spiral conducting path each have a width in the horizontal direction of 0.14 mm.

5. The antenna arrangement of claim 4, wherein the first spiral conducting path is coupled to a first conducting path, and the second spiral conducting path is coupled to a second conducting path.

6. The antenna arrangement of claim 5, wherein the first conducting path and the second conducting path each have a width in the horizontal direction of between 0.5 and 1.5 mm.

7. The antenna arrangement of claim 6, wherein the first conducting path and the second conducting path each have a width in the horizontal direction of 0.9 mm.

8. The antenna arrangement of claim 7, wherein the first conducting path and the second conducting path are 50Ω microstrip lines.

9. The antenna arrangement of claim 8, wherein the at least two conducting paths comprise copper.

10. The antenna arrangement of claim 9, wherein the at least two conducting paths have a thickness in a vertical direction of between 0.4 and 0.6 mm, wherein the vertical direction is a direction perpendicular to the surface of the printed circuit board on which the conducting paths are formed.

11. The antenna arrangement of claim 10, wherein the antenna comprises a conducting path on the printed circuit board.

12. The antenna arrangement of claim 11, wherein the antenna is a monopole antenna or an inverted-F antenna.

13. An electronic vehicle key comprising an antenna arrangement, the antenna arrangement comprising
an antenna; and
an antenna circuit configured to control the antenna; wherein
the antenna and the antenna circuit are arranged on a printed circuit board,
the antenna arrangement is configured to transmit and receive ultra-wide band signals or signals according to a Bluetooth standard, and
the antenna circuit comprises a filter arrangement configured to filter signals received by and to be sent by the antenna, wherein the filter arrangement comprises a capacitance formed by at least two conducting paths formed on the printed circuit board.

14. The electronic vehicle key of claim 13, wherein the capacitance comprises a bi-spiral shape comprising a first spiral conducting path and a second spiral conducting path spiraling into each other.

15. The electronic vehicle key of claim 14, wherein the first spiral conducting path and the second spiral conducting path each have a width in a horizontal direction of between 0.1 and 0.2 mm, wherein the horizontal direction is a direction parallel to a surface of the printed circuit board on which the first spiral conducting path and the second spiral conducting path are formed.

16. The electronic vehicle key of claim 15, wherein the first spiral conducting path and the second spiral conducting path each have a width in the horizontal direction of 0.14 mm.

17. The electronic vehicle key of claim 16, wherein the first spiral conducting path is coupled to a first conducting path, and the second spiral conducting path is coupled to a second conducting path.

18. The electronic vehicle key of claim 17, wherein the first conducting path and the second conducting path each have a width in the horizontal direction of between 0.5 and 1.5 mm.

19. The electronic vehicle key of claim 18, wherein the first conducting path and the second conducting path each have a width in the horizontal direction of 0.9 mm.

20. The electronic vehicle key of claim 19, wherein the first conducting path and the second conducting path are 50Ω microstrip lines.

21. The electronic vehicle key of claim 20, wherein the at least two conducting paths comprise copper.

22. The electronic vehicle key of claim 21, wherein the at least two conducting paths have a thickness in a vertical direction of between 0.4 and 0.6 mm, wherein the vertical direction is a direction perpendicular to the surface of the printed circuit board on which the conducting paths are formed.

23. The electronic vehicle key of claim 22, wherein the antenna comprises a conducting path on the printed circuit board.

24. The electronic vehicle key of claim 23, wherein the antenna is a monopole antenna or an inverted-F antenna.
